(19) United States
(12) Patent Application Publication
(10) Pub. No.: US 2023/0203222 A1
(43) Pub. Date: Jun. 29, 2023

(54) POLYMERIZABLE COMPOSITION, INK, CURED SUBSTANCE, ELECTRONIC COMPONENT, AND METHOD FOR MANUFACTURING ELECTRODE MEMBER

(71) Applicant: JNC CORPORATION, Tokyo (JP)

(72) Inventor: Katsuyuki SUGIHARA, Chiba (JP)

(73) Assignee: JNC CORPORATION, Tokyo (JP)

(21) Appl. No.: 17/923,601

(22) PCT Filed: Jun. 16, 2021
(86) PCT No.: PCT/JP2021/022885

§ 371 Date: Nov. 7, 2022

(30) Foreign Application Priority Data
Jun. 17, 2020 (JP) 2020-104845

(51) Int. Cl. C08F 220/58; C08F 220/56; C08F 222/10; C08F 2/48; C09D 11/101; C09D 11/107; H01M 4/04

(52) U.S. Cl. CPC C08F 220/58; C08F 220/56; C08F 222/102; C08F 2/48; C09D 11/101; C09D 11/107; H01M 4/0404

(57) ABSTRACT

A polymerizable composition curable by ionizing radiation contains (A) a first component including a (meth)acryloylmorpholine represented by formula (1), and (B) a second component including a compound represented by formula (2). The total content of the first component and the second component in the polymerizable composition is 50 wt % or more. The polymerizable composition enables appropriate maintaining of a post-curing shape even after being in a high temperature environment, and enables dissolution thereof by a water-containing solution. In formula (1), R¹ is hydrogen or methyl. In formula (2), R² is hydrogen or a group having 1 to 6 carbons, R³ and R⁴ are each independently hydrogen or a group having 20 or less carbons, and n is an integer of 1 to 6.

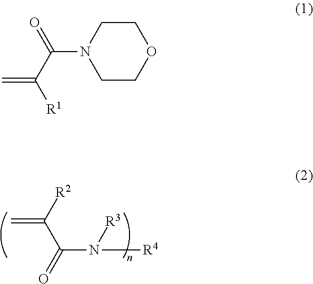

### TECHNICAL FIELD

This invention relates to a polymerizable composition that can be suitably used when collectively forming electrodes in response to high-density mounting, an ink including the above polymerizable composition, a transfer matrix including an ionizing radiation cured substance obtained by irradiating the above polymerizable composition with an ionizing radiation, and a method for manufacturing an electrode member including an electrode group formed on a base material using the above polymerizable composition.

### BACKGROUND ART

As a technology for collectively forming electrodes on a plurality of semiconductor devices (ICs) formed on a wafer in wafer level-chip size packaging (WL-CSP) which is one form of high-density mounting, Patent Literature 1 discloses a double laminated film which has lower layer formed from a non-radiation-sensitive resin composition and an upper layer formed from a negative-type radiation-sensitive resin composition and enables compatibility between high resolution properties and easy stripping properties, and a method for forming a bump using such a double laminated film.

### CITATION LIST

### Patent Literature

Patent Literature 1: Japanese Patent Laid-Open No. 2007-79550

### SUMMARY OF INVENTION

### Technical Problem

In the above-mentioned double laminated film disclosed in Patent Literature 1, at the time of development, in the upper layer, only the portion irradiated with radiation remains, and in the lower layer, the portion corresponding to the removed portion (non-radiation-irradiated portion) in the upper layer is dissolved and removed. Therefore, only the radiation-irradiated portion of the double laminated film remains, and the non-radiation-irradiated portion of the double laminated film is removed in the development stage. A metal paste is embedded in the portion from which the double laminated film has been removed as above, and the metal paste is reflowed by heating a wafer itself, thereby collectively forming a plurality of bumps on the wafer. After collectively forming the bumps in this manner, the double laminated film remaining on the wafer is removed with an organic solvent-based stripping solution such as dimethyl sulfoxide (DMSO).

In recent years, the shape of a negative pattern (transfer matrix) formed on a wafer to form bumps has become more complex (including three-dimensionalization) as mounting density has increased. However, steps become complicated when attempting to form a negative pattern having a complicated shape by a process of forming a negative pattern using a double laminated film as described above. Therefore, simplification of manufacturing steps is expected. In addition, the material constituting the negative pattern and remaining on the wafer is required to be reliably removed after the bumps are formed, but due to the growing interest in environmental issues, there is a demand for materials that can be removed with an aqueous stripping solution instead of the above-mentioned organic solvent-based stripping solution.

Furthermore, in a recent high-density mounting technology, fan-out type WLP in which a re-distribution layer is formed in a wide region exceeding a chip area has been adopted, and this fan-out type WLP also realizes a stack module for laminating multiple layers. In such fan-out type WLP, a large number of conductive pillars made of copper or the like are formed in the re-distribution layer, and a connecting material such as solder balls is disposed on the conductive pillars. Because the disposition accuracy of this connecting material increases as the mounting density increases, there is a demand for more accurate disposition of the connecting material on the conductive pillars.

An object of this invention is to provide an ionizing radiation curable polymerizable composition which enables appropriate maintaining of a post-curing shape even after being in a high temperature environment such as a reflow process (where such a characteristic is referred to as “heat resistance” in the present specification), and which can be dissolved by a solution containing water (referred to as a “water-containing solution” in this specification), which are required with the progress of such a mounting technology. Another object of this invention is to provide an ink including such a polymerizable composition, a transfer matrix including an ionizing radiation cured substance obtained by irradiating the above-mentioned polymerizable composition with ionizing radiation, and a method for manufacturing an electrode member including an electrode group on a base material using the above-mentioned polymerizable composition. In this specification, the term “ionizing radiation” has a meaning of a generic term for energy sources capable of generating radicals by irradiating or colliding a polymerization initiator with electromagnetic waves such as γ-rays, X-rays, ultraviolet rays, and visible light, electrons, protons, ions, and the like. Furthermore, in this specification, “(meth)acryloylmorpholine” may be written to represent one or both of “acryloylmorpholine” and “methacryloylmorpholine.” Terms relating to (meth)acryloylmorpholine, such as “(meth)acrylate” and “(meth)acryloxy,” also have similar meanings.

### Solution to Problem

This invention provided to achieve the above-mentioned objective is as follows.

[1] A polymerizable composition containing: (A) a first component including a (meth)acryloylmorpholine represented by formula (1), and (B) a second component including a compound represented by formula (2), wherein the total of the content of the first component and the content of the second component in the solid content of the polymerizable composition is 50 wt % or more.

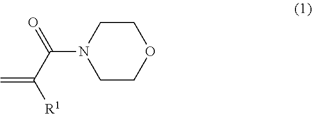

In formula (1), R¹ is hydrogen or methyl.

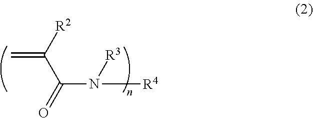

In formula (2), R² is hydrogen or a group having 1 to 6 carbons, R³ and R⁴ are each independently hydrogen or a group having 20 or less carbons, and n is an integer of 1 to 6.

[2] The polymerizable composition according to [1], in which n in the compound represented by formula (2) is 1.

[3] The polymerizable composition according to [2], in which R³ and R⁴ in the compound represented by formula (2) are each independently hydrogen or a group having 3 or less carbons.

[4] The polymerizable composition according to [3], in which in the compound represented by formula (2), R² is hydrogen, and R³ and R⁴ are methyl.

[5] The polymerizable composition according to any one of [1] to [4], in which the total of the content of the first component and the content of the second component in the solid content of the polymerizable composition is 74 wt % or more.

[6] The polymerizable composition according to any one of [1] to [5], in which the molar ratio between the first component and the second component in the polymerizable composition is 1/5 to 5/1 as the first component/the second component.

[7] The polymerizable composition according to any one of [1] to [6], further containing (C) a third component including a compound represented by formula (3).

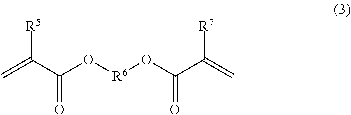

In formula (3), R⁶ is a group having 25 or less carbons, and R⁵ and R⁷ are each independently hydrogen or alkyl having 6 or less carbons.

[8] The polymerizable composition according to [7], in which R⁶ in the compound represented by formula (3) is an oxyalkylene-containing group.

[9] The polymerizable composition according to [7], in which R⁶ in the compound represented by formula (3) is a group comprising oxyalkylene.

[10] The polymerizable composition according to any one of [1] to [9] further containing (D) a fourth component including a polymerization initiator, wherein the content of the fourth component in the solid content of the polymerizable composition is 5 to 20 wt %.

[11] The polymerizable composition according to any one of [1] to [10] further containing (E) an antioxidant, wherein the content of the antioxidant in the solid content of the polymerizable composition is 0.01 to 10 wt %.

[12] The polymerizable composition according to any one of [1] to [11], of which the viscosity at 25° C. is 2 to 30 mPa·s.

[13] An ink for inkjet, containing the polymerizable composition according to any one of [1] to [12].

[14] A cured substance which is obtained by photocuring the polymerizable composition according to any one of [1] to [12].

[15] An electronic component which is produced using the cured substance according to [14].

[16] A method for manufacturing an electrode member in which a plurality of electrodes each having a recess is exposed on one surface of an insulating substrate in which wiring is embedded, the method including: a disposition step of disposing the polymerizable composition according to any one of [1] to [12] on a base material; a curing step of curing the polymerizable composition disposed on the base material by irradiating the polymerizable composition with an ionizing radiation to obtain a transfer matrix including an ionizing radiation cured substance; a conductive member forming step of forming a conductive member by disposing a conductive material to cover the transfer matrix; a stripping step of stripping a structure including the transfer matrix and the conductive member from the base material to expose a plurality of conductive members corresponding to the plurality of electrodes together with a surface of the transfer matrix on the side of the base material and adhered to the conductive member; and a dissolution step of dissolving the transfer matrix adhered to each of the plurality of conductive members using a water-containing solution containing poly(oxyethylene)=alkyl ether to obtain the plurality of electrodes having the recesses having a reverse shape of the transfer matrix.

[17] The method for manufacturing an electrode member according to [16], further including a heating step of heating the reverse matrix on the base material after the curing step and before start of the dissolution step.

[18] The method for manufacturing an electrode member according to [16] or [17], in which in the disposition step, the polymerizable composition is supplied to the base material to dispose a pattern of an applied substance of the polymerizable composition on the base material, and in the curing step, the pattern of the applied substance of the polymerizable composition on the base material is cured to form a pattern of the ionizing radiation cured substance on the base material as the transfer matrix.

[18] The method for manufacturing an electrode member according to [18], in which the polymerizable composition is an inkjet ink, and in the disposition step, the pattern of the applied substance of the polymerizable composition is disposed on the base material using an inkjet printer.

[20] The method for manufacturing an electrode member according to [16] or [17], in which in the disposition step, a layer of the polymerizable composition is formed on the base material, and in the curing step, a layer of the ionizing radiation cured substance is formed from the layer of the polymerizable composition, the method further including, before start of the conductive member forming step, a patterning step of forming a pattern of the ionizing radiation cured substance on the base material as the transfer matrix by irradiating a part of the layer of the ionizing radiation cured substance with high-energy rays to remove the ionizing radiation cured substance.

[21] The method for manufacturing an electrode member according to any one of [16] to [20], in which in the conductive member forming step, a plurality of electrically independent patterns of the conductive members is formed on the base material, the wiring electrically connected to each of the plurality of patterns of the conductive members is further formed, and an insulating material is disposed around the plurality of patterns of the conductive members and the wiring to form the insulating substrate on the base material, and the structure stripped from the base material in the stripping step includes the transfer matrix and the insulating substrate.

### Advantageous Effects of Invention

According to this invention, a polymerizable composition, which enables appropriate maintaining of a post-curing shape even after being in a high temperature environment (meaning having heat resistance) and enables formation of an ionizing radiation cured substance capable of being dissolved by a water-containing solution, is provided. Furthermore, according to this invention, an ink including the above polymerizable composition, an ionizing radiation cured substance obtained by irradiating the above-mentioned polymerizable composition with ionizing radiation, and a method for manufacturing an electrode member including an electrode group on a base material using the above-mentioned polymerizable composition are provided.

### BRIEF DESCRIPTION OF DRAWINGS

FIG. 1 is a flowchart of a manufacturing method according to the present embodiment.

FIG. 2 is a diagram for illustrating from a disposition step (step S101) to a curing step (step S102).

FIG. 3 is a diagram for illustrating a disposition step (step S101), a curing step (step S102), and a patterning step (step S103).

FIG. 4 is a diagram for illustrating a conductive member disposition step (step S104), a stripping step (step S105), and a dissolution step (step S106).

### DESCRIPTION OF EMBODIMENTS

A polymerizable composition, an ink, an ionizing radiation cured substance, and a method for manufacturing an electrode member according to embodiments of this invention will be described below.

A polymerizable composition according to one embodiment of this invention is a polymerizable composition containing: (A) a first component including a (meth)acryloylmorpholine represented by formula (1); and (B) a second component represented by formula (2).

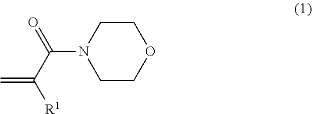

In formula (1), R¹ is hydrogen or methyl.

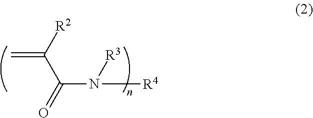

In formula (2), R² is hydrogen or a group (organic group) having 1 to 6 carbons, R³ and R⁴ are each independently hydrogen or a group having 20 or less carbons, and n is an integer of 1-6.

When the polymerizable composition contains the (meth)acryloylmorpholine represented by formula (1) and the compound represented by formula (2), appropriate heat resistance can be imparted to an ionizing radiation cured substance while ensuring curing properties and the solubility of the ionizing radiation cured substance in a water-containing solution.

When the polymerizable composition is irradiated with ionizing radiation, a polymerization initiator generates radicals, which initiate radical polymerization of acryloyl groups contained in the polymerizable composition, resulting in a solid component of the ionizing radiation cured substance. When light is used as the ionizing radiation, the polymerizable composition is a photocurable composition.

When the polymerizable composition contains the first component and the second component which are monofunctional compounds, the solubility of the ionizing radiation cured substance in the water-containing solution can be ensured as well as photocuring properties and heat resistance.

When the total (hereinafter also referred to as “total content”) of the content of the first component and the content of the second component in the solid content (the component constituting the ionizing radiation cured substance among the components contained in the polymerizable composition) of the polymerizable composition is 50 wt % or more, curing properties, and the heat resistance and the solubility in the water-containing solution of the ionizing radiation cured substance can be favorable. The total content is more preferably 74 wt % or more and further preferably 80 wt % or more from the viewpoint of realizing well-balanced curing properties, heat resistance, and solubility. In addition, the total content is preferably 96 wt % or less and more preferably 94 wt % or less from the viewpoint of improving photocuring properties. In the solid content of the polymerizable composition, the content of the first component is preferably 25 to 75 wt %, and the content of the second component is preferably 15 to 65 wt %.

The molar ratio between the first component and the second component in the polymerizable composition is preferably 1/5 to 5/1, more preferably 1/3 to 3/1, and further preferably 1/2 to 2/1 as the first component/second component from the viewpoint of realizing curing properties, and the ionizing radiation cured substance having heat resistance and solubility in the water-containing solution.

The second component is preferably a compound in which n in formula (2) is 1, is more preferably a compound in which R³ and R⁴ in formula (2) are each independently hydrogen or a group having 3 or less carbon atoms, and is further preferably a compound in which R² is hydrogen and R³ and R⁴ are methyl in formula (2) from the viewpoint of more stably ensuring the solubility of the ionizing radiation cured substance in the water-containing solution.

Specific and preferable examples of the second component include N,N-dimethylacrylamide, N,N-diethylacrylamide, N,N-dimethylmethacrylamide, N-methylmethacrylamide, and N-methylacrylamide. N,N-dimethylacrylamide is particularly preferable because it dissolves in a water-containing solution (aqueous stripping solution) containing a non-volatile water-soluble compound that is not a so-called volatile organic compound (VOC). By using a constitution in which the water-containing solution does not contain a volatile organic compound, the load on the environment can be further reduced.

From the viewpoint of increasing the residual film rate of the ionizing radiation cured substance after a high temperature process, the polymerizable composition preferably further contains a third component containing a compound represented by formula (3).

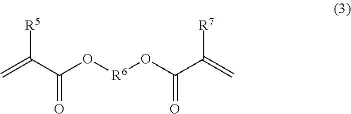

In formula (3), R⁶ is a group having 25 or less carbon atoms, and R⁵ and R⁷ are each independently hydrogen or alkyl having 6 or less carbon atoms.

The residual film rate is defined by (thickness after heat treatment)/(thickness before heat treatment) before and after the ionizing radiation cured substance according to the present embodiment is heated in the atmosphere (for example, at 200° C. for 2 hours, at 230° C. for 2 hours, or the like). By increasing the residual film rate, even when a metal such as copper is directly formed on a pattern formed from the ionizing radiation cured substance by a dry process such as vapor deposition or sputtering, the shape of the pattern is less likely to change.

Specific examples of the third component including the compound represented by formula (3) include a bisphenol F ethylene oxide-modified diacrylate (available as “ARONIX M-208” manufactured by Toagosei Co., Ltd.), a bisphenol A ethylene oxide-modified diacrylate (available as “ARONIX M-211B” manufactured by Toagosei Co., Ltd.), a PEG 200 #diacrylate (available as “LIGHT ACRYLATE 4EG-A” manufactured by KYOEISHA CHEMICAL Co., LTD.), a tripropylene glycol diacrylate (available as “VISCOAT #310HP” manufactured by OSAKA ORGANIC CHEMICAL INDUSTRY LTD.), and a 1,6-hexanediol diacrylate (available as “LIGHT ACRYLATE 1,6-HXA” manufactured by KYOEISHA CHEMICAL Co., LTD.). Among them, R⁶ in the compound represented by formula (3) is preferably bisphenol F ethylene oxide-modified diacrylate, which is a group containing oxyalkylene (alkylene oxide), bisphenol A ethylene oxide-modified diacrylate, PEG 200 #diacrylate, or tripropylene glycol diacrylate, from the viewpoint of the solubility of the ionizing radiation cured substance in the water-containing solution, and furthermore, R⁶ in the compound represented by formula (3) is preferably PEG 200 #diacrylate, which is a group composed of oxyalkylene, or tripropylene glycol diacrylate, because then the solubility is increased.

In the polymerizable composition, bifunctional acrylate compounds having, for example, an aliphatic polycyclic structure instead of a bisphenol structure can be used in place of the third component that is a monomer of a bifunctional acrylate compound, within a range not impairing the solubility of the ionizing radiation cured substance in the water-containing solution.

When the polymerizable composition contains the third component, the content of the third component in the solid content is preferably 5 wt % or more and 35 wt % or less, more preferably 8 wt % or more and 33 wt % or less, and particularly preferably 10 parts by weight or more and 30 wt % or less from the viewpoint of maintaining the residual film rate of the ionizing radiation cured substance after a high temperature process and the solubility of the ionizing radiation cured substance in the water-containing solution.

In addition, the molar ratio of the third component to the total of the first component and the second component is preferably 1/20 to 1/2, more preferably 1/15 to 1/3, and further preferably 1/10 to 1/5 as the third component/(total of the first and the second components).

The polymerizable composition of this invention may contain a compound other than those described above as long as the heat resistance and the solubility of the ionizing radiation cured substance can be appropriately ensured. Examples of acrylic compounds positioned as optionally added components include monofunctional acrylic compounds having an aliphatic polycyclic structure such as a norbornene skeleton or a dicyclopentadiene skeleton (where these acrylic compounds are referred to as “aliphatic polycyclic monoacrylic compounds” in the present specification). When the polymerizable composition contains the aliphatic polycyclic monoacrylic compound, the glass transition point of the ionizing radiation cured substance formed from the polymerizable composition can be increased in some cases.

Specific examples of such aliphatic polycyclic monoacrylic compounds include a dicyclopentanyl methacrylate (available as “FA-513M” manufactured by Hitachi Chemical Co., Ltd.), a dicyclopentanyl acrylate (available as “FA-513AS” manufactured by Hitachi Chemical Co., Ltd.), an isobornyl acrylate (available as “LIGHT ESTER IB-XA” manufactured by KYOEISHA CHEMICAL Co., LTD.), and an isobornyl methacrylate (available as “LIGHT ESTER IB-X” manufactured by KYOEISHA CHEMICAL Co., LTD.). When the polymerizable composition contains the aliphatic polycyclic monoacrylic compound, the content thereof in the solid content of the polymerizable composition is preferably 20 wt % or less and more preferably 15 wt % or less from the viewpoint of appropriately ensuring the heat resistance and the solubility of the ionizing radiation cured substance.

The polymerizable composition of this invention may further contain (D) a fourth component including a polymerization initiator. The type of the polymerization initiator is not limited as long as it can generate radicals when being irradiated with ionizing radiation and can initiate the polymerization reaction of the first component and the second component.

The content of the polymerization initiator in the solid content of the polymerizable composition is preferably 5 wt % or more from the viewpoint of the solubility of the ionizing radiation cured substance, and is preferably 20 wt % or less from the viewpoint of the heat resistance. The content thereof is more preferably 8 wt % or more and 15 wt % or less from the viewpoint of obtaining the ionizing radiation cured substance having well-balanced solubility and heat resistance.

Specific examples of the polymerization initiator include benzophenone, Michler's ketone, 4,4′-bis(diethylamino)benzophenone, xanthone, thioxanthone, isopropyl xanthone, 2,4-diethylthioxanthone, 2-ethylanthraquinone, acetophenone, 2-hydroxy-2-methylpropiophenone, 2-hydroxy-2-methyl-4′-isopropylpropiophenone, 1-hydroxycyclohexyl phenyl ketone, benzoin isopropyl ether, benzoin isobutyl ether, 2,2-diethoxyacetophenone, 2,2-dimethoxy-2-phenylacetophenone, 1,1′-(methylene-di-4,1-phenylene)bis(2-hydroxy-2-methyl-1-propanone), camphorquinone, benzanthrone, 2-methyl-1-[4-(methylthio)phenyl]-2-morpholinopropan-1-one, 2-(4-methylbenzyl)-2-(dimethylamino)-1-(4-morpholinophenyl)butan-1-one, ethyl 2-benzyl-2-dimethylamino-1-(4-morpholinophenyl)-butanone-1,4-dimethylaminobenzoate, isoamyl 4-dimethylaminobenzoate, 4,4′-di(tert-butylperoxycarbonyl)benzophenone, 3,4,4′-tri(tert-butylperoxycarbonyl)benzophenone, 2,4,6-trimethylbenzoyldiphenylphosphine oxide, 2-(4′-methoxystyryl)-4,6-bis(trichloromethyl)-s-triazine, 2-(3′,4′-dimethoxystyryl)-4,6-bis(trichloromethyl)-s-triazine, 2-(2′,4′-dimethoxystyryl)-4,6-bis(trichloromethyl)-s-triazine, 2-(2′-methoxystyryl)-4,6-bis(trichloromethyl)-s-triazine, 2-(4′-pentyloxystyryl)-4,6-bis(trichloromethyl)-s-triazine, 4-[p-N,N-di(ethoxycarbonylmethyl)]-2,6-di(trichloromethyl)-s-triazine, 1,3-bis(trichloromethyl)-5-(2′-chlorophenyl)-s-triazine, 1,3-bis(trichloromethyl)-5-(4′-methoxyphenyl)-s-triazine, 2-(p-dimethylaminostyryl)benzoxazole, 2-(p-dimethylaminostyryl)benzothiazole, 2-mercaptobenzothiazole, 3,3′-carbonylbis(7-diethylaminocoumarin), 2-(o-chlorophenyl)-4,4′,5,5′-tetraphenyl-1,2′-biimidazole, 2,2′-bis(2-chlorophenyl)-4,4′,5,5′-tetrakis(4-ethoxycarbonylphenyl)-1,2′-biimidazole, 2,2′-bis(2,4-dichlorophenyl)-4,4′,5,5′-tetraphenyl-1,2′-biimidazole, 2,2′-bis(2,4-dibromophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 3-(2-methyl-2-dimethylaminopropionyl)carbazole, 3,6-bis(2-methyl-2-morpholinopropionyl)-9-n-dodecylcarbazole, bis(η5-2,4-cyclopentadien-1-yl)-bis(2,6-difluoro-3-(1H-pyrrol-1-yl)-phenyl)titanium, 3,3′,4,4′-tetra(tert-butylperoxycarbonyl)benzophenone, 3,3′,4,4′-tetra(tert-hexylperoxycarbonyl)benzophenone, 3,3′-di(methoxycarbonyl)-4,4′-di(tert-butylperoxycarbonyl)benzophenone, 3,4′-di(methoxycarbonyl)-4,3′-di(tert-butylperoxycarbonyl)benzophenone, and 4,4′-di(methoxycarbonyl)-3,3′-di(tert-butylperoxycarbonyebenzophenone. These compounds may be used alone, and it is also effective to use a mixture of two or more thereof. Examples of commercially available products include product names: Irgacure 379EG, Irgacure 127, and Irgacure 184 which are manufactured by BASF, and product names: Omnirad 379EG, Omnirad 127, and Omnirad 184 which are manufactured by IGM Resins B.V. Among these, 2-(4-methylbenzyl)-2-(dimethylamino)-1-(4-morpholinophenyl)butan-1-one is preferable.

The polymerizable composition according to the present embodiment may not substantially contain a volatile solvent from the viewpoint of simplifying a step of forming an ionizing radiation cured substance, but may contain a volatile solvent from the viewpoint of adjusting the viscosity of the polymerizable composition. The volatile solvent may be mixed with other compositions when being used to constitute the polymerizable composition. When the polymerizable composition contains the volatile solvent, volatilization may start when the polymerizable composition is in an uncured state, and volatilization is preferably caused at least at the stage, in which the ionizing radiation cured substance is formed, by appropriate heating before, during, and/or after irradiation with ionizing radiation. When an excessive amount of a non-volatile solvent remains even in the state where the polymerizable composition has cured to some extent, a final cured substance (ionizing radiation cured substance) will have a porous structure, resulting in a deterioration of surface properties (surface smoothness) required as a reverse matrix (negative pattern) for reverse transfer. Therefore, the content of the volatile solvent is preferably 30 wt % or less with respect to the entire polymerizable composition.

Specific examples of the volatile solvent include methanol, ethanol, propanol, butanol, butyl acetate, butyl propionate, ethyl lactate, methyl oxyacetate, ethyl oxyacetate, butyl oxyacetate, methyl methoxyacetate, ethyl methoxyacetate, butyl methoxyacetate, methyl ethoxyacetate, ethyl ethoxyacetate, methyl 3-oxypropionate, ethyl 3-oxypropionate, methyl 3-methoxypropionate, ethyl 3-methoxypropionate, methyl 3-ethoxypropionate, ethyl 3-ethoxypropionate, methyl 2-oxypropionate, ethyl 2-oxypropionate, propyl 2-oxypropionate, methyl 2-methoxypropionate, ethyl 2-methoxypropionate, propyl 2-methoxypropionate, methyl 2-ethoxypropionate, ethyl 2-ethoxypropionate, methyl 2-oxy-2-methylpropionate, ethyl 2-oxy-2-methylpropionate, methyl 2-methoxy-2-methylpropionate, ethyl 2-ethoxy-2-methylpropionate, methyl pyruvate, ethyl pyruvate, propyl pyruvate, methyl acetoacetate, ethyl acetoacetate, methyl 2-oxobutanoate, ethyl 2-oxobutanoate, methyl 2-hydroxyisobutyrate, dioxane, propylene glycol monomethyl ether, propylene glycol monoethyl ether, propylene glycol monopropyl ether, propylene glycol monobutyl ether, propylene glycol monophenyl ether, ethylene glycol monobutyl ether, ethylene glycol monophenyl ether, diethylene glycol monomethyl ether, diethylene glycol monoethyl ether, diethylene glycol monopropyl ether, diethylene glycol monobutyl ether, diethylene glycol monophenyl ether, dipropylene glycol monomethyl ether, dipropylene glycol monoethyl ether, dipropylene glycol monopropyl ether, dipropylene glycol monobutyl ether, dipropylene glycol monophenyl ether, ethylene glycol, diethylene glycol, propylene glycol, dipropylene glycol, glycerin, benzyl alcohol, cyclohexanol, 1,4-butanediol, triethylene glycol, tripropylene glycol, propylene glycol monomethyl ether acetate, propylene glycol monoethyl ether acetate, propylene glycol monopropyl ether acetate, dipropylene glycol monoethyl ether acetate, dipropylene glycol monobutyl ether acetate, ethylene glycol monobutyl ether acetate, cyclohexanone, cyclopentanone, diethylene glycol monomethyl ether acetate, diethylene glycol monoethyl ether acetate, diethylene glycol monobutyl ether acetate, diethylene glycol dimethyl ether, diethylene glycol diethyl ether, diethylene glycol methyl ethyl ether, toluene, xylene, anisole, γ-butyrolactone, N,N-dimethylacetamide, N-methyl-2-pyrrolidone, and dimethylimidazolidinone. These compounds may be used alone, and it is also effective to use a mixture of two or more thereof.

The polymerizable composition according to the present embodiment may contain an additive other than the above-mentioned components. Specific examples of other additives include surfactants, polymerization inhibitors, plasticizers, antioxidants, ultraviolet absorbers, antistatic agents, flame retardants, flame retardant aids, fillers, pigments, and dyes, but are not particularly limited as long as they can be uniformly mixed with the other components within the range not deviating from the scope of this invention. Specific examples of the surfactants include Polyflow No. 45, Polyflow KL-245, Polyflow No. 75, Polyflow No. 90, and Polyflow No. 95 (trade names, all manufactured by KYOEISHA CHEMICAL Co., LTD.), DISPERBYK 161, DISPERBYK 162, DISPERBYK 163, DISPERBYK 164, DISPERBYK 166, DISPERBYK 170, DISPERBYK 180, DISPERBYK 181, DISPERBYK 182, BYK 300, BYK 306, BYK 310, BYK 320, BYK 330, BYK 342, BYK 344, and BYK 346 (trade names, all manufactured by BYK-Chemie Japan Co., Ltd.), KP-341, KP-358, KP-368, KF-96-50CS, and KF-50-100CS (trade names, all manufactured by Shin-Etsu Chemical Co., Ltd.), SURFLON SC-101 and SURFLON KH-40 (trade names, both manufactured by AGC SEIMI CHEMICAL CO., LTD.), FTERGENT 222F, FTERGENT 251, and FTX-218 (trade names, all manufactured by Neos Corporation), TEGO Rad 2100, 2200N, 2250, 2500, 2600, and 2700 (trade names, all manufactured by Evonik Degussa), EFTOP EF-351, EFTOP EF-352, EFTOP EF-601, EFTOP EF-801, and EFTOP EF-802 (trade names, all manufactured by Mitsubishi Materials Corporation), MEGAFACE F-171, MEGAFACE F-177, MEGAFACE F-444, MEGAFACE F-475, MEGAFACE F-477, MEGAFACE F-556, MEGAFACE R-08, and MEGAFACE R-30 (trade names, all manufactured by DIC Corporation), fluoroalkylbenzenesulfonate, fluoroalkylcarboxylate, fluoroalkylpolyoxyethylene ether, fluoroalkylammonium iodide, fluoroalkylbetaine, fluoroalkylsulfonate, perfluoroalkylethylene oxide adduct, diglycerin tetrakis(fluoroalkyl polyoxyethylene ether), fluoroalkyltrimethylammonium salt, fluoroalkylaminosulfonate, polyoxyethylene nonylphenyl ether, polyoxyethylene octyl phenyl ether, polyoxyethylene lauryl ether, polyoxyethylene oleyl ether, polyoxyethylene tridecyl ether, polyoxyethylene cetyl ether, polyoxyethylene stearyl ether, polyoxyethylene laurate, polyoxyethylene oleate, polyoxyethylene stearate, polyoxyethylene laurylamine, sorbitan laurate, sorbitan palmitate, sorbitan stearate, sorbitan oleate, sorbitan fatty acid ester, polyoxyethylene sorbitan laurate, polyoxyethylene sorbitan palmitate, polyoxyethylene sorbitan stearate, polyoxyethylene sorbitan oleate, polyoxyethylene naphthyl ether, alkylbenzene sulfonate, and alkyldiphenyl ether disulfonate.

Specific examples of the polymerization inhibitors include 4-methoxyphenol, hydroquinone, and phenothiazine.

As the antioxidants, hindered phenol-based antioxidants, phosphorus-based processing heat stabilizers, metal deactivators, sulfur-based heat-resistant stabilizers, hydroquinone derivatives, and the like are preferable. Specific examples thereof include Irganox 1010, Irganox 1010FF, Irganox 1035, Irganox 1035FF (W&C), Irganox 1076, Irganox 1076FD, Irganox 1098, Irganox 1135, Irganox 1330, Irganox 1520L, Irganox 245, Irganox 245FF, Irganox 259, Irganox 3114, and Irganox 565 (trade names, all made by BASF), NOCRAC 200 and NOCRAC NS-6 (trade names, both OUCHI SHINKO CHEMICAL INDUSTRIAL CO., LTD.), ADK STAB AO-40, ADK STAB AO-50, ADK STAB AO-60, ADK STAB AO-80, ADK STAB AO-330, ADK STAB HP-10, and ADEKA ARKLS GPA5001 (trade names, all made by ADEKA Corporation), KEMINOX 101 (trade name, made by Chemipro Kasei Co., Ltd.), Cyanox CY-1790 (trade name, made by SUN CHEMICAL COMPANY LTD.), Antiox 10 (trade name, made by NOF CORPORATION), dibutylhydroxytoluene, and 4-methoxyphenol. Among them, Irganox 1330 (melting point: 240° C. to 245° C.) having a high melting point and low volatility is particularly preferable.

The content of the antioxidant in the solid content of the polymerizable composition is preferably 0.01 to 10 wt %, more preferably 0.1 to 5 wt %, and further preferably 0.4 to 2 wt % from the viewpoint of improving the solubility of the cured polymerizable composition.

By supplying the polymerizable composition according to the present embodiment onto a base material by application, dropwise addition, or the like when being used, the polymerizable composition has a film-like shape or a predetermined pattern on the base material. The viscosity at 25° C. of the polymerizable composition according to the present embodiment is preferably 2 to 30 mPa·s in some cases from the viewpoint of enhancing the ease of such a supplying of the polymerizable composition onto the base material. The above-mentioned viscosity range is preferably satisfied particularly when the polymerizable composition is supplied onto the base material by an inkjet printer. Furthermore, the viscosity at an ejection temperature (for example, 25° C.) of an inkjet ink including the polymerizable composition according to the present embodiment is preferably 25 mPa·s or less, and particularly preferably 10 mPa·s or less. The viscosity of the polymerizable composition can be lowered by heating.

The polymerizable composition according to the present embodiment is cured by being irradiated with ionizing radiation to become the ionizing radiation cured substance. Such an ionizing radiation cured substance is soluble in the water-containing solution even after being heated at 200° C. for 2 hours in the atmosphere. As a specific example, the ionizing radiation cured substance after the above-mentioned heat treatment (at 200° C. for 2 hours) is dissolved by being immersed in the water-containing solution for 15 hours or shorter, or 30 minutes or shorter in a preferable aspect.

The water-containing solution is a solution containing water, and may be constituted of water, but is preferably a mixed solvent with a water-soluble compound having a high solubility in water. Any water-soluble compound can be used as long as it is a compound having a boiling point of 70° C. or higher, but it is preferable to incorporate a compound having a boiling point of 150° C. or higher from the viewpoint of ease of handling, and it is more preferable to incorporate a compound having a boiling point of 260° C. or higher from the viewpoint of VOC.

From the viewpoint of improving the uniformity of the mixed solution, examples of the water-soluble compound having a high solubility in water include protic polar solvents such as alcohols, and compounds having oxyethylene groups such as poly(oxyethylene)=alkyl ethers. Non-volatile poly(oxyethylene)=alkyl ether is more preferable from the viewpoint of safety and reduction of environmental load. The content of water in the water-containing solution is appropriately set according to the types of components other than water contained in the water-containing solution and the composition of the ionizing radiation cured substance.

When the water-containing solution is formed from a water-poly(oxyethylene)=alkyl ether mixed solution which is a mixed solution of water and poly(oxyethylene)=alkyl ether, the number n of added moles of ethylene oxide in poly(oxyethylene)=alkyl ether (H2ₘ₊₁Cₘ—O—(CH₂—CH₂—O)ₙ—H) is not particularly limited, but is preferably 2 to 35, more preferably 15 to 30, and further preferably 20 to 25. In addition, the alkyl chain length m is preferably 4 to 15 and more preferably 12 to 13.

Examples of the poly(oxyethylene)=alkyl ether include diethylene glycol butyl ether (CAS No: 112-34-5) in which the number n of added moles of ethylene oxide is 2, triethylene glycol monododecyl ether (CAS No: 3055-94-5) in which the number n of added moles of ethylene oxide is 3, and polyoxyethylene (23) lauryl ether (CAS No: 9002-92-0) in which the number n of added moles of ethylene oxide is 23. From the viewpoint of safety and reducing environmental load, it is preferable to use polyoxyethylene (23) lauryl ether as the poly(oxyethylene)=alkyl ether, and the content in the water-containing solution is preferably 10 wt % or more and 90 wt % or less, more preferably 30 wt % or more and 80 wt % or less, and particularly preferably 50 wt % or more and 70 wt % or less.

When the water-containing solution is formed from a water-alcohol mixed solution which is a mixed solution of water and alcohol, and when the alcohol contained in the water-alcohol mixed solution is a substance having 4 or less carbon atoms such as ethanol and isopropanol, the content of the alcohol is preferably 25 wt % or more and 90 wt % or less, more preferably 40 wt % or more and 80 wt % or less, and particularly preferably 45 wt % or more and 75 wt % or less.

The water-containing solution may contain an organic solvent other than the alcohol. Examples of such an organic solvent include aprotic organic solvents such as N-methylpyrrolidone, acetone, acetonitrile, and dimethylsulfoxide. The content of the organic solvent other than the alcohol in the water-containing solution is preferably 20 wt % or less with respect to the entire water-containing solution from the viewpoint of reducing environmental load.

The water-containing solution is preferably alkaline, that is, an alkaline solution in some cases. Examples of substances for making the water-containing solution alkaline include 5 inorganic alkaline substances such as sodium hydroxide and potassium hydroxide, and organic alkaline substances such as tetramethylammonium hydroxide. The pH of a general alkaline solution is 9 or more, and the pH of the water-containing solution is also preferably 9 or more in some cases, and is more preferably 10 or more in some cases. From the viewpoint of realizing such a pH, the content of the alkaline substance in the water-containing solution is preferably 5 wt % or more and 20 wt % or less in some cases.

Hereinafter, a method for manufacturing an electrode member, which can also be used as a re-distribution line (RDL) used in fan-out type WLP and the like and in which a plurality of electrodes each having a recess and is exposed on one surface of an insulating substrate in which wiring is embedded, will be described. A material constituting the electrodes includes copper (Cu) for example, and a material constituting the insulating substrate includes polyimide for example.

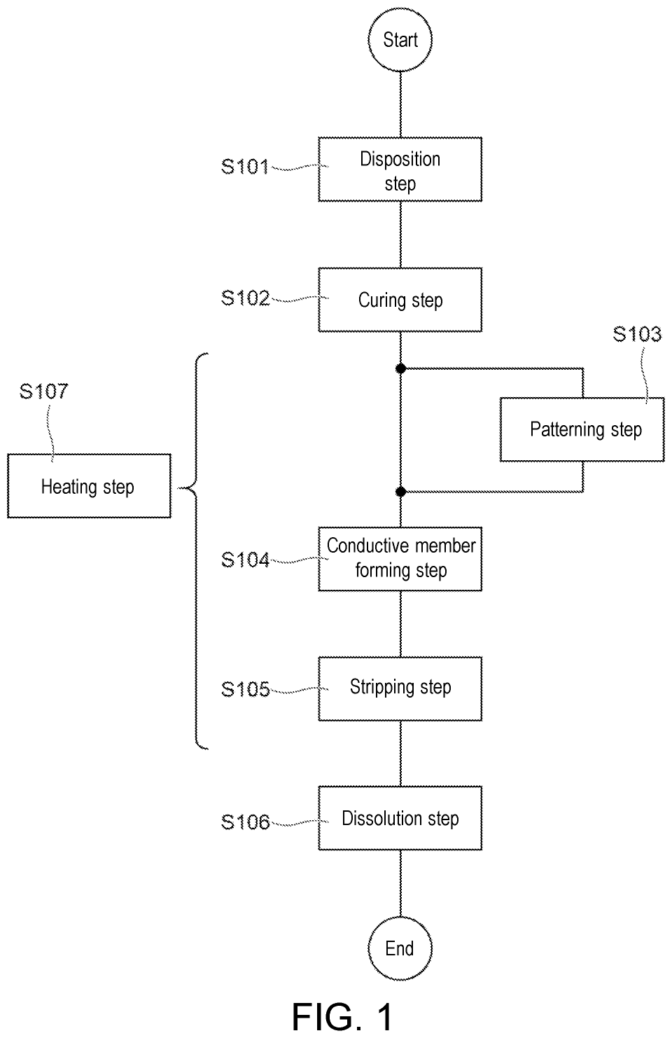

FIG. 1 is a flowchart of a manufacturing method according to the present embodiment. As shown in FIG. 1, the present manufacturing method includes a disposition step (step S101), a curing step (step S102), a conductive member forming step (step S104), a stripping step (step S105), and a dissolution step (step S106) as essential steps. The present manufacturing method may include a patterning step (step S103) between the curing step (step S102) and the conductive member disposition step (step S104) as necessary, or may include a heating step (step S107) after the curing step (step S102) and before the start of a dissolution step (step S106) as necessary.

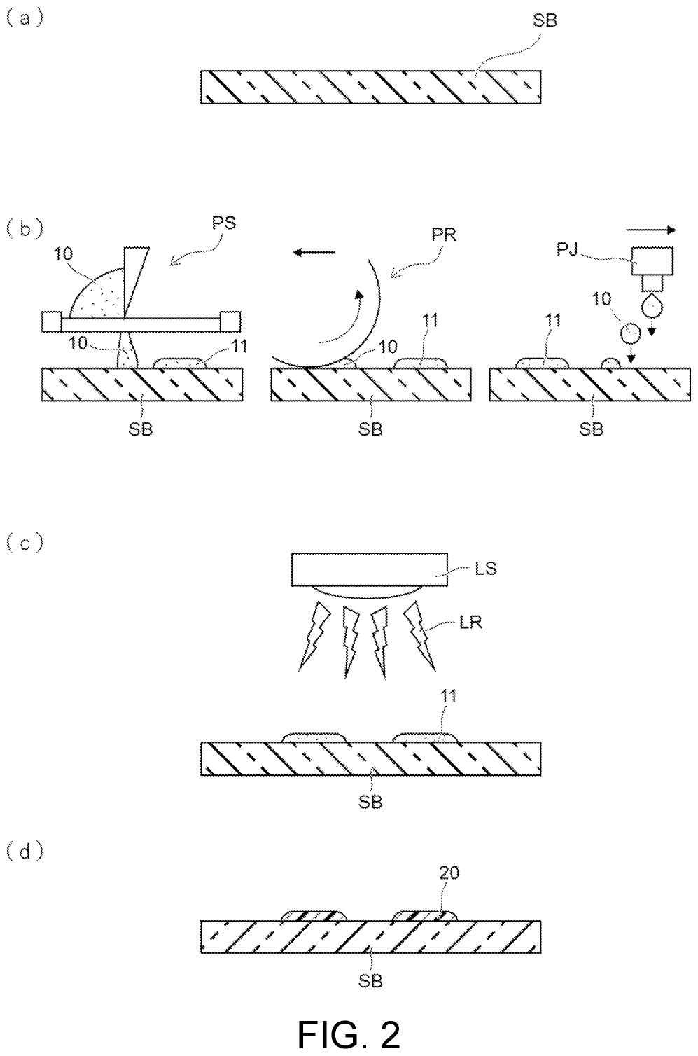

FIG. 2 is a diagram for illustrating from the disposition step (step S101) to the curing step (step S102) included in one example of the manufacturing method according to the present embodiment.

In the disposition step (step S101), a polymerizable composition 10 described above is disposed on one main surface of a plate-like or sheet-like base material SB (FIG. 2(a)), which is finally stripped, such as a glass substrate and a silicon substrate. A method for disposing the polymerizable composition 10 is not limited. In FIG. 2, FIG. 2(b) shows an example in which a pattern 11 of an applied substance of the polymerizable composition is formed on the base material SB using various known disposition means such as a screen printer PS (left), an offset printer PR (center) using a transfer roll, and an inkjet printer PJ (right).

In the curing step, the pattern 11 of the applied substance of the polymerizable composition disposed on the base material SB is irradiated with ionizing radiation LR (FIG. 2(c)) to cure the pattern 11 of the applied substance of the polymerizable composition, thereby obtaining a pattern 20 of an ionizing radiation cured substance on the base material SB as a transfer matrix (FIG. 2(d)). The type of the ionizing radiation LR is not particularly limited, and examples thereof include visible light, ultraviolet light, X-rays, γ-rays, electron beams, and ion beams. An irradiation device LS is appropriately set according to the type of the ionizing radiation LR. Specific examples thereof include LEDs, halogen lamps, radiation irradiation devices, electron beam irradiation devices, and ion beam generating sources. UV-LEDs and halogen lamps having the light emission peak at about 350 nm to about 400 nm are suitably used from the viewpoint of availability and ease of handling.

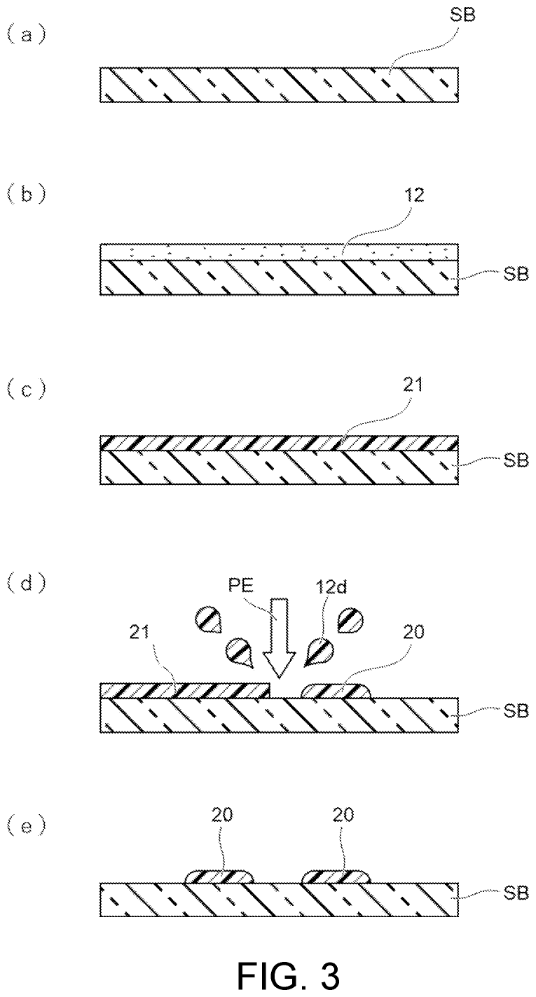

FIG. 3 is a diagram for illustrating the disposition step (step S101), the curing step (step S102), and the patterning step (step S103) included in another example of the manufacturing method according to the present embodiment.

In the disposition step (step S101), as shown in FIG. 3(b), a layer 12 of the polymerizable composition is formed on one main surface (FIG. 3(a)) of the base material SB. Examples of methods for forming the layer 12 of the polymerizable composition include spin coating, a dipping method, and spray coating. Thereafter, the curing step (step S102) is performed to form a layer 21 of the ionizing radiation cured substance on one main surface of the base material SB as shown in FIG. 3(c).

Thereafter, a part of the layer 21 of the ionizing radiation cured substance is irradiated with high-energy rays PE (where specific examples thereof include a laser and an ion beam) to remove an unnecessary ionizing radiation cured substance 12d. In this manner, the patterning step (step S103) of forming a transfer matrix including the pattern 20 of the ionizing radiation cured substance on the base material SB is performed.

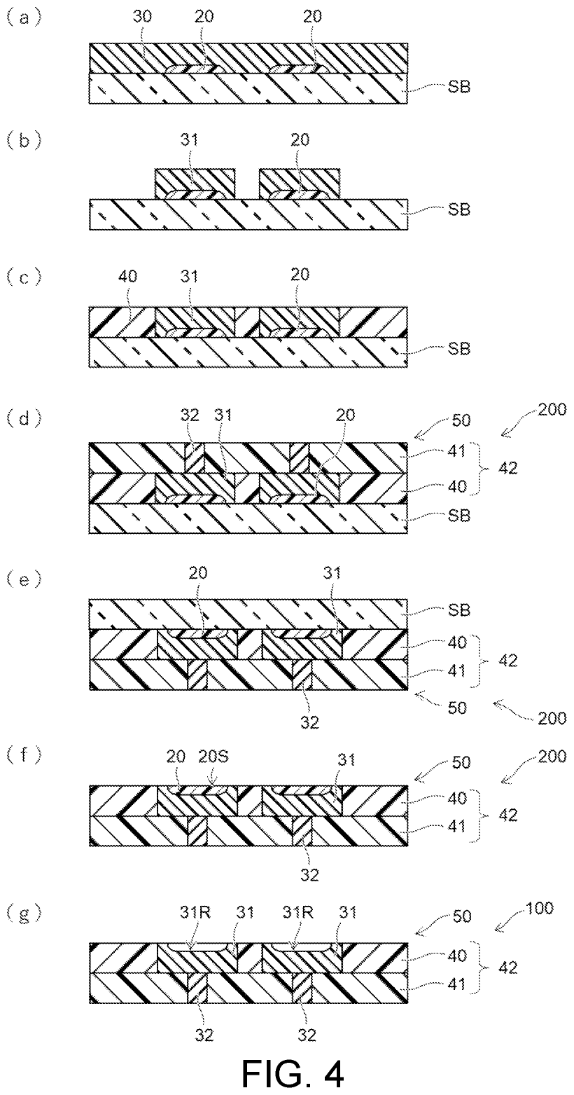

FIG. 4 is a diagram for illustrating the conductive member disposition step (step S104), the stripping step (step S105), and the dissolution step (step S106) included in one example of the manufacturing method according to the present embodiment.

Once the structure in which the pattern 20 of the ionizing radiation cured substance is formed on the base material SB is obtained through the manufacturing steps shown in FIG. 2 or FIG. 3, the conductive member forming step (step S104) of forming a conductive member film 30 is performed by disposing a conductive material to cover the pattern 20 of the ionizing radiation cured substance on the base material SB. As a specific example of the conductive member forming step (step S104), FIG. 4(a) shows a case of forming a film-like conductive member film 30 by evenly disposing a conductive material on one main surface of the base material SB.

The type of the conductive material is not particularly limited, but any one can be used as long as the conductive member film 30 is impermeable to water and has the function as a protective layer for the pattern 20 of the ionizing radiation cured substance, because this increases a degree of freedom in setting subsequent processes. From this viewpoint, examples of the conductive material include metallic materials such as copper (Cu) and aluminum (Al), inorganic oxide materials such as indium tin oxide (ITO) and zinc oxide (ZnO), and conductive materials in which conductive nanowires are dispersed in a resin. A method for manufacturing the conductive member film 30 is appropriately set according to the type of the conductive material. When the conductive material is made of a metallic material such as copper (Cu), specific examples include a method for forming the entire conductive member film 30 by a dry process such as vapor deposition or sputtering, and a method for forming the conductive member film 30 on the base material SB by forming a thin layer of a conductive material to cover the pattern 20 of the ionizing radiation cured substance on the base material SB by a dry process such as vapor deposition or sputtering, and thereafter accumulating the conductive material by a wet process such as plating.

When the conductive material is accumulated by a dry process, the conductive material moving toward the base material SB may have a high temperature or have high kinetic energy in some cases. In this case, the base material SB is heated, and as a result, the pattern 20 of the ionizing radiation cured substance on the base material SB may also have a high temperature. In such a case, it is regarded that the heating step (step S107) is substantially performed in the conductive member forming step (step S104). Even when the heating step (step S107) is substantially performed in this manner, as described above, the pattern 20 of the ionizing radiation cured substance can be appropriately dissolved in the water-containing solution containing poly(oxyethylene)=alkyl ether in the subsequent dissolution step, and the shape change due to heat is small.

Once the conductive member film 30 is formed on the base material SB as above, a part of the conductive member film 30 is removed by irradiating it with high-energy rays such as a laser to obtain a pattern 31 of the conductive member formed to cover each pattern 20 of the ionizing radiation cured substance (FIG. 4(b)). The high-energy rays radiated in this process may heat the base material SB and the pattern 31 of the conductive member. Such a case is also regarded that the heating step (step S107) is substantially performed in the conductive member forming step (step S104). Even when heat is transferred to the pattern 20 of the ionizing radiation cured substance in this manner, as described above, the solubility in the water-containing solution can be appropriately maintained, and the shape change is less likely to occur.

In FIGS. 4(a) and 4(b), the pattern 31 of the conductive member is formed after forming the conductive member film 30 by the conductive member forming step (step S104), but this invention is not limited thereto. The pattern 31 of the conductive member may be formed directly by using a suitable mask material, or the like.

Subsequently, as shown in FIG. 4(c), an insulating material 40 such as polyimide is disposed around the pattern 31 of the conductive member on the base material SB to facilitate further lamination of members on the pattern 31 of the conductive member provided on the base material SB. A specific method of this process is arbitrary. For example, the insulating material 40 may be applied by spin coating or the like to be disposed by photolithography (including curing) in which heat treatment is performed. In this case, since the heat treatment is performed, the pattern 20 of the ionizing radiation cured substance covered with the pattern 31 of the conductive member in contact with the insulating material 40 is also heated. Therefore, this heat treatment corresponds to the heating step (step S107) performed before the start of the stripping step (step S105) described below. The heating step (step S107) of performing such heat treatment can be performed since the solubility in the water-containing solution is unlikely to deteriorate and the shape change due to heating is less likely to occur even when the ionizing radiation cured substance according to the present embodiment is heated as described above.

After appropriately disposing the insulating material 40 around the pattern 31 of the conductive member in this manner, lamination and patterning (or lamination while patterning) of the conductive material are further performed to form a wiring member 32 on the pattern 31 of the conductive member, and an insulating material 41 such as polyimide is disposed around the wiring member 32 (FIG. 4(d)). A plurality of layers formed from the wiring member 32 and the insulating material 41 may be provided in some cases. Even when it is regarded that the heating step (step S107) is substantially performed because the process of forming the layer formed from the wiring member 32 and the insulating material 41 includes heat treatment, as described above, the solubility of the ionizing radiation cured substance in the water-containing solution is appropriately maintained, and the shape change due to heating is less likely to occur. As above, a structure 200 is disposed on the base material SB, the structure including the pattern 20 of the ionizing radiation cured substance constituting the transfer matrix, the pattern 31 of the conductive member constituting the electrode, the wiring member 32 constituting the wiring, and an insulating substrate 50 formed from an insulating part 42 constituted of the insulating materials 40 and 41.

The structure 200 thus obtained is reversed to position the base material SB on the upper side of the structure 200 (FIG. 4(e)), and the base material SB is stripped. At this time, since the pattern 20 of the ionizing radiation cured substance remains adhesion to the pattern 31 of the conductive member, that is, the transfer matrix is in the state of being adhered to each of the plurality of conductive members, a surface 20S (the surface disposed to face the base material SB), which is on the base material SB side, of the pattern 20 of the ionizing radiation cured substance is exposed in the structure 200 (FIG. 4(f)). By bringing the pattern 20 of the ionizing radiation cured substance including this exposed surface 20S into contact with the water-containing solution, the pattern 20 of the ionizing radiation cured substance can be dissolved and removed. As a result, as shown in FIG. 4(g), the pattern 31 of the conductive member having a surface of a recess 31R, which is the reverse shape of the pattern 20 of the ionizing radiation cured substance, is exposed, and each of these patterns 31 of the conductive members becomes an electrode of an electrode member. In this manner, an electrode member 100, in which a plurality of electrodes (the patterns 31 of the conductive members) each having the recess 31R is exposed on one surface of the insulating substrate 50 in which the wiring (wiring member 32) is embedded, is obtained.

In the case in which the exposed part of the electrode has the recess 31R as above, this recess 31R functions as a receiving part for a solder ball when the electrode member is used as re-distribution, which improves the stability of the mounted solder ball. Therefore, the disposition density of the electrodes in re-distribution can be increased, and the mounting density can be improved.

By the above-described manufacturing method, the individual conductive member constituting the pattern 31 of the conductive member becomes an electrode, and thereby an electrode member in which the electrode and a wiring electrically connected to the electrode are embedded in a support member (formed from the insulating material 40 and the insulating material 41) can be manufactured.

Although this invention has been described with reference to the above-mentioned embodiments, this invention is not limited to the above-mentioned embodiments and can be improved or changed within the scope of the purpose of improvement or the spirit of this invention.

### EXAMPLES

This invention will be described in more detail with reference to examples and the like, but the scope of this invention is not limited to these examples and the like.

The following materials were prepared.

(A) First Component: (Meth)Acryloylmorpholine

ACMO (CAS No. 5117-12-4) acryloylmorpholine (Tg: 145° C.)

(B) Second Component

DMAA (CAS No. 2680-03-7) N,N-dimethylacrylamide (Tg: 119° C.)

DEAA (CAS No. 2675-94-7) N,N-diethylacrylamide (Tg: 81° C.)

NIPA (CAS No. 2210-25-5) isopropyl acrylamide (Tg: 150° C.)

(C) Third Component

4EG-A (CAS No. 26570-48-9) PEG #200 diacrylate (Tg: 40° C.)

M208 (CAS No. 120750-67-6) bisphenol F EO modified diacrylate (Tg: 75° C.)

(Other Compounds)

NVC (CAS No. 2235-00-9) N-vinyl-ε-caprolactam (Tg: 145° C.)

4HBA (CAS No. 2478-10-6) 4-hydroxybutyl acrylate (Tg: −40° C.)

(D) Fourth Component: Polymerization Initiator

Irg 379EG: 2-(4-methylbenzyl)-2-(dimethylamino)-1-(4-morpholinophenyl)butan-1-one (manufactured by BASF, “IRGACURE 379EG”)

(E) Antioxidant

Irganox 1330 (manufactured by BASF)

(Surfactant)

BYK 342 (manufactured by BYK-Chemie Japan Co., Ltd.)

### Example 1 to Example 15 and Comparative Example 1 to Comparative Example 6

As shown in Table 1 to Table 4, various materials were blended to prepare polymerizable compositions. Numerical values in each table mean parts by weight.

TABLE 1
Table 1

| | | Example | | | | |
|---|---|---|---|---|---|---|
| | | 1 | 2 | 3 | 4 | 5 |
| (A) | ACMO | 4.05 | 2.94 | 1.61 | 2.63 | 2.78 |
| (B) | DMAA | 0.95 | 2.06 | 3.39 | | |
| | DEAA | | | | 2.37 | |
| | NIPA | | | | | 2.22 |
| (C) | 4EG-A | | | | | |
| | M208 | | | | | |
| Other | NVC | | | | | |
| | 4HBA | | | | | |
| (D) | IRG 379 | 0.60 | 0.60 | 0.60 | 0.60 | 0.60 |
| (E) | Irganox 1330 | | | | | |
| Surfactant | BYK 342 | 0.0028 | 0.0028 | 0.0028 | 0.0028 | 0.0028 |

TABLE 2
Table 2

| | | Example | | | | | |
|---|---|---|---|---|---|---|---|
| | | 6 | 7 | 8 | 9 | 10 | 11 |
| (A) | ACMO | 2.58 | 2.40 | 2.24 | 1.95 | 2.94 | 2.94 |
| (B) | DMAA | 1.81 | 1.69 | 1.57 | 1.37 | 2.06 | 2.06 |
| | DEAA | | | | | | |
| | NIPA | | | | | | |
| (C) | 4EG-A | 0.61 | | 1.19 | | | |
| | M208 | | 0.92 | | 1.68 | | |
| Other | NVC | | | | | | |
| | 4HBA | | | | | | |
| (D) | IRG 379 | 0.60 | 0.60 | 0.60 | 0.60 | 0.15 | 0.30 |
| (E) | Irganox 1330 | | | | | | |
| Surfactant | BYK 342 | 0.0028 | 0.0028 | 0.0028 | 0.0028 | 0.0026 | 0.00265 |

TABLE 3
Table 3

| | | Example | | | |
|---|---|---|---|---|---|
| | | 12 | 13 | 14 | 15 |
| (A) | ACMO | 2.94 | 2.94 | 2.58 | 2.58 |
| (B) | DMAA | 2.06 | 2.06 | 1.81 | 1.81 |
| | DEAA | | | | |
| | NIPA | | | | |
| (C) | 4EG-A | | | 0.61 | 0.61 |
| | M208 | | | | |
| Other | NVC | | | | |
| | 4HBA | | | | |
| (D) | IRG 379 | 0.90 | 1.30 | 0.60 | 0.60 |
| (E) | Irganox 1330 | | | 0.0280 | 0.0560 |
| Surfactant | BYK 342 | 0.00295 | 0.0032 | 0.0028 | 0.0028 |

TABLE 4
Table 4

| | | Comparative Example | | | | | |
|---|---|---|---|---|---|---|---|
| | | 1 | 2 | 3 | 4 | 5 | 6 |
| (A) | ACMO | 5.00 | | 2.52 | 2.47 | 1.60 | 1.25 |
| (B) | DMAA | | 5.00 | | | 1.13 | 0.88 |
| | DEAA | | | | | | |
| | NIPA | | | | | | |
| (C) | 4EG-A | | | | | 2.27 | |
| | M208 | | | | | | 2.87 |
| Other | NVC | | | 4.98 | | | |
| | 4HBA | | | | 2.53 | | |
| (D) | IRG 379 | 0.60 | 0.60 | 0.60 | 0.60 | 0.60 | 0.60 |
| (E) | Irganox 1330 | | | | | | |
| Surfactant | BYK 342 | 0.0028 | 0.0028 | 0.0028 | 0.0028 | 0.0028 | 0.0028 |

Table 5 to Table 8 show the content (concentration of solid content) in the solid content of each component contained in the polymerizable compositions according to the examples and the comparative examples, and the evaluation results. In Table 5 to Table 8, from the viewpoint of facilitating comparison, the total of the content of (A) the first component and the content of (B) the second component in the solid content contained in the polymerizable composition is shown in the section of (A)+(B), the molar ratio of each component is shown in the section of Molar ratio (A/B/C/other), the first component/second component (molar ratio) is shown in the section of Molar ratio (A/B), and the third component/(total of the first component and the second component) (molar ratio) is shown in the section of Molar ratio [C/(A+B)]. In Table 5 to Table 8, % means wt %.

TABLE 5
Table 5

| | | Example | | | | |
|---|---|---|---|---|---|---|
| Weight ratio of each component | | 1 | 2 | 3 | 4 | 5 |
| (A) | ACMO | 72% | 52% | 29% | 47% | 50% |
| (B) | DMAA | 17% | 37% | 60% | | |
| | DEAA | | | | 42% | |
| | NIPA | | | | | 40% |
| (A) + (B) | | 89% | 89% | 89% | 89% | 89% |
| (C) | 4EG-A | | | | | |
| | M208 | | | | | |
| Other | NVC | | | | | |
| | 4HBA | | | | | |
| (D) | IRG379 | 11% | 11% | 11% | 11% | 11% |
| (E) | Irganox1330 | | | | | |
| Surfactant | BYK342 | 0.050% | 0.050% | 0.050% | 0.050% | 0.050% |
| Molar ratio (A/B/C/other) | | 3/1/—/— | 1/1/—/— | 1/3/—/— | 1/1/—/— | 3/1/—/— |
| Molar ratio (A/B) | | 3/1 | 1/1 | 1/3 | 1/1 | 3/1 |
| Molar ratio [C/(A + B)] | | | | | | |
| Viscosity (mPa · s) | | 8.1 | 4.4 | 2.49 | 5.43 | 19.44 |
| Photocuring properties | | ◯ | ◯ | ◯ | ◯ | ◯ |
| Heat resistance | | ◯ | ◯ | ◯ | ◯ | ◯ |
| Tg (° C.) | | 133 | 135 | 126 | 147 | 149 |
| Solubility | KOH/water/POE ether solution | ⊚ | ⊚ | ⊚ | X | X |
| Cured at 200° C. | KOH/water/EtOH solution | ⊚ | ⊚ | ⊚ | ⊚ | ⊚ |
| Cured at 230° C. | KOH/water/POE ether solution | — | — | — | — | — |

—: not measured

TABLE 6
Table 6

| | | Example | | | | | |
|---|---|---|---|---|---|---|---|
| Weight ratio of each component | | 6 | 7 | 8 | 9 | 10 | 11 |
| (A) | ACMO | 46% | 43% | 40% | 35% | 57% | 55% |
| (B) | DMAA | 32% | 30% | 28% | 24% | 40% | 39% |
| | DEAA | | | | | | |
| | NIPA | | | | | | |
| (A) + (B) | | 78% | 73% | 68% | 59% | 97% | 94% |
| (C) | 4EG-A | 11% | | 21% | | | |
| | M208 | | 16% | | 30% | | |
| Other | NVC | | | | | | |
| | 4HBA | | | | | | |
| (D) | IRG379 | 11% | 11% | 11% | 11% | 3% | 6% |
| (E) | Irganox1330 | | | | | | |
| Surfactant | BYK342 | 0.050% | 0.050% | 0.050% | 0.050% | 0.050% | 0.050% |
| Molar ratio (A/B/C/other) | | 9/9/1/— | 9/9/1/— | 8/8/2/— | 8/8/2/— | 1/1/—/— | 1/1/—/— |
| Molar ratio (A/B) | | 1/1 | 1/1 | 1/1 | 1/1 | 1/1 | 1/1 |
| Molar ratio [C/(A + B)] | | 1/18 | 1/18 | 1/8 | 1/8 | | |
| Viscosity (mPa · s) | | 5.35 | 8.16 | 6.37 | 15.25 | 3.29 | 3.69 |
| Photocuring properties | | ◯ | ◯ | ◯ | ◯ | Δ | ◯ |
| Heat resistance | | ◯ | ◯ | ◯ | ◯ | ⊚ | ◯ |
| Tg (° C.) | | 129 | 130 | 120 | 121 | 159 | 140 |
| Solubility | KOH/water/POE ether solution | Δ | Δ | Δ | X | Δ | ◯ |
| Cured at 200° C. | KOH/water/EtOH solution | ◯ | ◯ | ◯ | ◯ | ◯ | ⊚ |
| Cured at 230° C. | KOH/water/POE ether solution | X | — | — | — | — | — |

—: not measured

TABLE 7
Table 7

| | | Example | | | |
|---|---|---|---|---|---|
| Weight ratio of each component | | 12 | 13 | 14 | 15 |
| (A) | ACMO | 50% | 47% | 46% | 46% |
| (B) | DMAA | 35% | 33% | 32% | 32% |
| | DEAA | | | | |
| | NIPA | | | | |
| (A) + (B) | | 85% | 79% | 78% | 78% |
| (C) | 4EG-A | | | 11% | 11% |
| | M208 | | | | |
| Other | NVC | | | | |
| | 4HBA | | | | |
| (D) | IRG379 | 15% | 21% | 11% | 11% |
| (E) | Irganox1330 | | | 0.50% | 1.00% |
| Surfactant | BYK342 | 0.050% | 0.050% | 0.050% | 0.050% |
| Molar ratio (A/B/C/other) | | 1/1/—/— | 1/1/—/— | 9/9/1/— | 9/9/1/— |
| Molar ratio (A/B) | | 1/1 | 1/1 | 1/1 | 1/1 |
| Molar ratio [C/(A + B)] | | | | 1/18 | 1/18 |
| Viscosity (mPa · s) | | 5.25 | 5.8 | 5.5 | 5.7 |
| Photocuring properties | | ◯ | ◯ | ◯ | ◯ |
| Heat resistance | | ◯ | Δ | ◯ | ◯ |
| Tg (° C.) | | 125 | 117 | 127 | 124 |
| Solubility | KOH/water/POE ether solution | ⊚ | ⊚ | ◯ | ⊚ |
| Cured at 200° C. | KOH/water/EtOH solution | ⊚ | ⊚ | ⊚ | ⊚ |
| Cured at 230° C. | KOH/water/POE ether solution | — | — | ⊚ | ⊚ |

—: not measured

TABLE 8
Table 8

| | | Comparative Example | | | | | |
|---|---|---|---|---|---|---|---|
| Weight ratio of each component | | 1 | 2 | 3 | 4 | 5 | 6 |
| (A) | ACMO | 89% | | 45% | 44% | 29% | 22% |
| (B) | DMAA | | 89% | | | 20% | 16% |
| | DEAA | | | | | | |
| | NIPA | | | | | | |
| (A) + (B) | | 89% | 89% | 45% | 44% | 49% | 38% |
| (C) | 4EG-A | | | | | 41% | |
| | M208 | | | | | | 51% |
| Other | NVC | | | 44% | | | |
| | 4HBA | | | | 45% | | |
| (D) | IRG379 | 11% | 11% | 11% | 11% | 11% | 11% |
| (E) | Irganox1330 | | | | | | |
| Surfactant | BYK342 | 0.050% | 0.050% | 0.050% | 0.050% | 0.050% | 0.050% |
| Molar ratio (A/B/C/other) | | 1/—/—/— | —/1/—/— | 1/—/—/1 | 1/—/—/1 | 6/6/4/— | 6/6/4/— |
| Molar ratio (A/B) | | | | | | 1/1 | 1/1 |
| Molar ratio [C/(A + B)] | | | | | | 1/3 | 1/3 |
| Viscosity (mPa · s) | | 16.3 | 1.67 | 10.8 | 12.25 | 8.94 | 48.2 |
| Photocuring properties | | ◯ | Δ | Δ | XX | ◯ | ◯ |
| Heat resistance | | ◯ | Δ | Δ | XX | X | Δ |
| Tg (° C.) | | 141 | 117 | 106 | 30 | 95 | 101 |
| Solubility | KOH/water/POE ether solution | X | ⊚ | X | X | Δ | X |
| Cured at 200° C. | KOH/water/EtOH solution | Δ | ⊚ | Δ | ◯ | ◯ | ◯ |
| Cured at 230° C. | KOH/water/POE ether solution | — | — | — | — | — | — |

—: not measured

### (Evaluation Example 1) Measurement of Viscosity

The viscosity at room temperature (25° C.) was measured for each of the polymerizable compositions according to the examples and the comparative examples. Tables 5 to Table 8 show the measurement results.

### (Evaluation Example 2) Evaluation of Photocuring Properties

For each of the polymerizable compositions according to the examples and the comparative examples, a coating film was obtained using a bar coater under the following conditions. The minimum exposure amount required for the coating film to become a tackless state was measured by varying the exposure amount.

Substrate: aluminum foil

Bar coater: #42 (target film thickness: 70 to 80 μm)

The obtained coating film of the polymerizable composition was cured under the following conditions to obtain an ionizing radiation cured substance.

UV irradiation device: “ASM 1503 NM-UV-LED” manufactured by ASUMI GIKEN, Limited

Lamp wavelength: 365 nm

From the exposure amount required for curing the coating film, the photocuring properties of the polymerizable composition was evaluated according to the following criteria.

B: cured at the exposure amount of less than 100 mJ/cm².

C: cured at the exposure amount of 100 mJ/cm² or more and less than 500 mJ/cm².

D: cured at the exposure amount of 500 mJ/cm² or more and less than 2000 mJ/cm².

E: cured at the exposure amount of 2000 mJ/cm² or more.

### (Evaluation Example 3) Evaluation of Heat Resistance (Measurement of Glass Transition Point (Tg))

For each of the polymerizable compositions according to the examples and the comparative examples, a coating film was obtained using a bar coater under the following conditions.

Substrate: aluminum foil

Bar coater: #42 (target film thickness: 70 to 80 μm)

The obtained coating film of the polymerizable composition was cured under the following conditions to obtain an ionizing radiation cured substance.

UV irradiation device: “ASM 1503 NM-UV-LED” manufactured by ASUMI GIKEN, Limited

Lamp wavelength: 365 nm

Exposure amount: 1000 mJ/cm²

Illuminance: 700 mW/cm²

For the measurement of UV light, a UV monitor (“UV-Pad” manufactured by Opsytec) that measures UVA (315 to 400 nm) was used.

The glass transition point (Tg) of the obtained ionizing radiation cured substance was measured by a dynamic mechanical analysis method (DMA method) under the following conditions.

Measurement device: DMS 6000 (manufactured by Hitachi High-Tech Corporation)

Frequency mode: sinusoidal wave frequency: 10 kHz

Temperature rising rate: 10° C./min

From the measured glass transition point, the heat resistance of the polymerizable composition was evaluated according to the following criteria.

⊚: the glass transition point of 150° C. or higher

◯: the glass transition point of 120° C. or higher and lower than 150° C.

Δ: the glass transition point of 100° C. or higher and lower than 120° C.

X: the glass transition point of 50° C. or higher and lower than 100° C.

XX: the glass transition point lower than 50° C.

### (Evaluation Example 4-1) Evaluation of Solubility

Each of the polymerizable compositions according to the examples and the comparative examples was applied onto a silicon substrate (silicon wafer) under the same conditions as in Evaluation Example 2, and cured to obtain an ionizing radiation cured substance. In addition, thereafter, the obtained ionizing radiation cured substance was heat-treated under the following conditions.

Clean oven: “DT 610” manufactured by Yamato Scientific Co., Ltd.

Temperature: 200° C.

Heating time: 2 hours

Subsequently, (A) an alkaline solution (KOH/water/POE ether solution) composed of a mixed solution of potassium hydroxide (KOH), water, and polyoxyethylene (23) lauryl ether (POE ether) (mixing weight ratio: KOH/water/POE ether=5/35/60), and (B) an alkaline solution (KOH/water/EtOH solution) composed of a mixed solution of potassium hydroxide (KOH), water, and ethanol (EtOH) (mixing weight ratio: KOH/water/EtOH=5/35/60) were prepared as a water-containing solution. The KOH/water/POE ether solution was heat-treated at 70° C. and the KOH/water/EtOH solution was heat-treated at 25° C., and thereafter the ionizing radiation cured substance was immersed therein to observe the dissolution state of the ionizing radiation cured substance. Evaluation criteria were as follows. The evaluation results are shown in Table 5 to Table 8.

⊚: dissolved within 30 minutes.

◯: dissolved within the period from a lapse of 30 minutes to 3 hours.

Δ: dissolved within the period from a lapse of 3 hours until a lapse of 15 hours.

X: not dissolved even after a lapse of 15 hours.

### (Evaluation Example 4-2) Evaluation of Solubility

The dissolution state of the ionizing radiation cured substance was observed in the same manner as in Evaluation Example 4-1 except that the conditions for heat-treating the obtained ionizing radiation cured substance were changed to the following conditions, and only a KOH/water/POE ether solution was prepared as a water-containing solution in which the ionizing radiation cured substance after heat treatment was immersed.

Clean oven: “DT 610” manufactured by Yamato Scientific Co., Ltd.

Temperature: 230° C.

Heating time: 2 hours

As shown in Table 5 to Table 8, the polymerizable compositions according to the examples had the viscosity of 10 mP·s or less at room temperature, and thus were suitable as an inkjet ink. In addition, in all the examples, favorable photocuring properties were shown.

The glass transition points (Tg) of the ionizing radiation cured substances formed from the polymerizable compositions according to the examples were 120° C. or higher, and it was confirmed that the glass transition points (Tg) of the obtained ionizing radiation cured substances were high.

The ionizing radiation cured substances formed from the polymerizable compositions according to the examples had favorable solubility in the KOH/water/EtOH solution even after the heat treatment. Examples 1 to 3, 6 to 8, and 10 to 15 were also soluble in the KOH/water/POE ether solution in addition to the KOH/water/EtOH solution, and both photocuring properties and heat resistance were favorable.

On the other hand, in the ionizing radiation cured substances formed from the polymerizable compositions according to Comparative Example 1 to Comparative Example 6, the solubility in the KOH/water/EtOH solution of the ionizing radiation cured substances after heat treatment tended to deteriorate. Although Comparative Examples 2 and 5 dissolved in the KOH/water/POE ether solution, both or one of photocuring properties and heat resistance was D or C.

From the results of Examples 2, 10, and 11 to 13, it can be said that the content of the polymerization initiator is preferably 5 wt % or more from the viewpoint of photocuring properties, and is preferably 20 wt % or less from the viewpoint of heat resistance.

From the comparison between Examples 6 and 8 and Comparative Example 5, it can be said that the total of the content of (A) and the content of (B) in the solid content of the polymerizable composition is preferably 50 wt % or more and more preferably 70 wt % or more from the viewpoint of obtaining the polymerizable composition having excellent photocuring properties, heat resistance, and solubility.

When the polymerizable composition of Example 6 not containing (E) the antioxidant, the polymerizable composition of Example 14 containing (E) the antioxidant, and the polymerizable composition of Example 15 containing (E) the antioxidant were cured at 200° C. in this order, the dissolution times thereof in the KOH/water/POE ether solution (70° C.) were 4 hours, 1 hour, and 0.25 hours, and the dissolution times thereof in the KOH/water/EtOH solution (25° C.) were 1.5 hours, 0.5 hours, and 0.25 hours. Furthermore, when they were cured at 230° C., the dissolution times thereof in the KOH/water/POE ether solution (70° C.) were X (insoluble), 2 hours, and 0.5 hours. From these results, it can be said that the antioxidant improves the solubility of the cured substance in the water-containing solution, and the content thereof is preferably 0.3 wt % and more preferably 0.7 wt % or more.

### REFERENCE SIGNS LIST

10: polymerizable composition
11: pattern of applied substance of polymerizable composition
12: layer of polymerizable composition
12d: unnecessary ionizing radiation cured substance
20: pattern of ionizing radiation cured substance
20S: exposed surface
21: layer of ionizing radiation cured substance
30: conductive member film
31: pattern of conductive member
31R: recess
32: wiring member
40, 41: insulating material
42: insulating part
50: insulating substrate
100: electrode member
200: structure
LR: ionizing radiation
LS: irradiation device
PE: high-energy rays
PJ: inkjet printer
PR: offset printer
PS: screen printer
SB: base material

1. A polymerizable composition comprising:
(A) a first component comprising a (meth)acryloylmorpholine represented by formula (1); and
(B) a second component comprising a compound represented by formula (2),
wherein a total of a content of the first component and a content of the second component in a solid content of the polymerizable composition is 50 wt % or more, 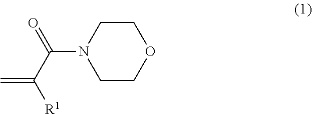
in formula (1), R¹ is hydrogen or methyl, and 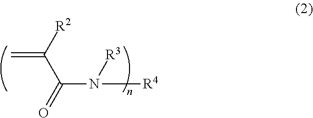
in formula (2), R² is hydrogen or a group having 1 to 6 carbon atoms, R³ and R⁴ are each independently hydrogen or a group having 20 or less carbons, and n is an integer of 1 to 6.

2. The polymerizable composition according to claim 1, wherein n in the compound represented by formula (2) is 1.

3. The polymerizable composition according to claim 2, wherein R³ and R⁴ in the compound represented by formula (2) are each independently hydrogen or a group having 3 or less carbons.

4. The polymerizable composition according to claim 3, wherein in the compound represented by formula (2), R² is hydrogen, and R³ and R⁴ are methyl.

5. The polymerizable composition according to claim 1, wherein the total of the content of the first component and the content of the second component in the solid content of the polymerizable composition is 74 wt % or more.

6. The polymerizable composition according to claim 1, wherein a molar ratio between the first component and the second component in the polymerizable composition is 1/5 to 5/1 as the first component/the second component.

7. The polymerizable composition according to claim 1, further comprising (C) a third component comprising a compound represented by formula (3), 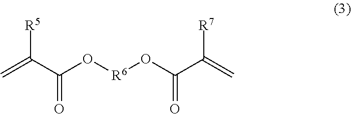
in formula (3), R⁶ is a group having 25 or less carbons, and R⁵ and R⁷ are each independently hydrogen or an alkyl having 6 or less carbons.

8. The polymerizable composition according to claim 7, wherein R⁶ in the compound represented by formula (3) is an oxyalkylene-containing group.

9. The polymerizable composition according to claim 7, wherein R⁶ in the compound represented by formula (3) is a group comprising oxyalkylene.

10. The polymerizable composition according to claim 1, further comprising (D) a fourth component comprising a polymerization initiator, wherein a content of the fourth component in the solid content of the polymerizable composition is 5 to 20 wt %.

11. The polymerizable composition according to claim 1, further comprising (E) an antioxidant, wherein a content of the antioxidant in the solid content of the polymerizable composition is 0.01 to 10 wt %.

12. The polymerizable composition according to claim 1, of which a viscosity at 25° C. is 2 to 30 mPa·s.

13. An ink for inkjet, comprising the polymerizable composition according to claim 1.

14. A cured substance, obtained by photocuring the polymerizable composition according to claim 1.

15. An electronic component, produced using the cured substance according to claim 14.

16. A method for manufacturing an electrode member in which a plurality of electrodes each having a recess is exposed on one surface of an insulating substrate in which wiring is embedded, comprising:
a disposition step of disposing the polymerizable composition according to claim 1 on a base material;
a curing step of curing the polymerizable composition disposed on the base material by irradiating the polymerizable composition with an ionizing radiation to obtain a transfer matrix comprising an ionizing radiation cured substance;
a conductive member forming step of forming a conductive member by disposing a conductive material to cover the transfer matrix;
a stripping step of stripping a structure including the transfer matrix and the conductive member from the base material to expose a plurality of conductive members corresponding to the plurality of electrodes together with a surface of the transfer matrix on a side of the base material and adhered to the conductive member; and
a dissolution step of dissolving the transfer matrix adhered to each of the plurality of conductive members using a water-containing solution containing poly(oxyethylene)=alkyl ether to obtain the plurality of electrodes having the recesses having a reverse shape of the transfer matrix.

17. The method for manufacturing an electrode member according to claim 16, further comprising: a heating step of heating the transfer matrix on the base material after the curing step and before start of the dissolution step.

18. The method for manufacturing an electrode member according to claim 16, wherein
in the disposition step, the polymerizable composition is supplied to the base material to dispose a pattern of an applied substance of the polymerizable composition on the base material, and
in the curing step, the pattern of the applied substance of the polymerizable composition on the base material is cured to form a pattern of the ionizing radiation cured substance on the base material as the transfer matrix.

19. The method for manufacturing an electrode member according to claim 18, wherein
the polymerizable composition is an inkjet ink, and
in the disposition step, the pattern of the applied substance of the polymerizable composition is disposed on the base material using an inkjet printer.

20. The method for manufacturing an electrode member according to claim 16, wherein
in the disposition step, a layer of the polymerizable composition is formed on the base material, and
in the curing step, a layer of the ionizing radiation cured substance is formed from the layer of the polymerizable composition,
the method further comprising, before start of the conductive member forming step, a patterning step of forming a pattern of the ionizing radiation cured substance on the base material as the transfer matrix by irradiating a part of the layer of the ionizing radiation cured substance with high-energy rays to remove the ionizing radiation cured substance.

21. The method for manufacturing an electrode member according to claim 16, wherein
in the conductive member forming step, a plurality of electrically independent patterns of the conductive members is formed on the base material, the wiring electrically connected to each of the plurality of patterns of the conductive members is further formed, and an insulating material is disposed around the plurality of patterns of the conductive members and the wiring to form the insulating substrate on the base material, and
the structure stripped from the base material in the stripping step comprises the transfer matrix and the insulating substrate.
